(19) United States
(12) Patent Application Publication
(10) Pub. No.: US 2011/0112256 A1
(43) Pub. Date: May 12, 2011

(54) USE AS A THICKENING AGENT OF SALINE AQUEOUS FORMULATIONS OF A WATER-SOLUBLE ACRYLIC COPOLYMER, WHICH IS CROSSLINKED AND HYDROPHOBICALLY MODIFIED

(75) Inventors: Yves Kensicher, Theize (FR); Jean-Marc Suau, Lucenay (FR)

(73) Assignee: COATEX S.A.S., Genay (FR)

(21) Appl. No.: 13/001,790

(22) PCT Filed: Jun. 9, 2009
(86) PCT No.: PCT/IB2009/005897

§ 371 Date: Dec. 29, 2010

(30) Foreign Application Priority Data
Jul. 3, 2008 (FR) 0854526
Oct. 3, 2008 (FR) 0856702

(51) Int. Cl. C08F 4/00

(52) U.S. Cl. 525/328.9; 526/216

(57) ABSTRACT

The invention consists in the use, as a thickening agent of an aqueous formulation which is, notably, salt-rich, of a water-soluble or alkali-soluble copolymer consisting of (by weight):
a) 30% to 45% of (meth)acrylic acid,
b) 50% to 60% of acrylamide and/or of N-methylol and/or of an acrylic ester,
c) 2% to 10% of a hydrophobic monomer of formula R₁—(R₂O)ₘ—R₃, in which:
   R₁ designates a polymerisable unsaturated group,
   R₂O designates an alkylene oxide group having 1 to 6 carbon atoms,
   m is an integer of between 20 and 50,
   R₃ designates a linear alkyl chain comprising at least 16 and at most 26 carbon atoms,
d) 0.1% to 4% of at least one cross-linking agent, which is preferentially ethyleneglycoldimethacrylate (EDMA).

It is, generally, a well-known technique to thicken an aqueous medium through the introduction of water-soluble polymers of natural or synthetic origin such as, in the case of the former, guar or xanthan gums, cellulose, polysaccharides, and in the case of the latter, polyacrylamides, copolymers of acrylic acid and of acrylamide, polyacrylates, copolymers of (meth)acrylic acid with other monomers. It is then said that these polymers are used as thickening agents.

However, there are certain applications in which the presence of electrolytes, such as salts of sodium, calcium or magnesium, will impair the efficacy of such thickening agents: this is for example the case with oil drilling fluids. In addition, these fluids are subject to very high shearing stresses: these stresses constitute a second factor prejudicing the thickening action of the polymers present in the medium, notably through the destruction of the lengthy macro-molecular chains. Finally, the temperature at which thickening agents are used in these fluids may exceed 100° C., often reaching 150° C., which may cause thermal degradation of the said thickening agents.

To overcome these constraints the skilled man in the art has favoured two types of solution: that with a xanthan gum base, and those reliant on acrylamide-based homopolymers and copolymers. Xanthan gum has the triple advantage that it has high salt tolerance, that it is stable up to temperatures close to 100° C., and that it does not tend to degrade under high shearing stresses (this is notably the initial teaching of document EP 0 226 097). Conversely, its high cost and its sensitivity to heat when temperatures close to 150° C. are reached, which is customary in typical drilling fluid applications, constitute serious disadvantages for its use in such fields.

The other approach is based on the use of polyacrylamides, and copolymers of acrylamide with other monomers. The wealth of the state of the art in this field demonstrates that this is the technical alternative which the skilled man in the art has favoured. With this regard, it is possible to cite documents FR 2 322 197, FR 2 498 200 and GB 2 077 750 relative to the use of polyacrylamides, documents U.S. Pat. No. 4,268,400, U.S. Pat. No. 4,423,199, U.S. Pat. No. 4,782,120, U.S. Pat. No. 4,566,978, U.S. Pat. No. 4,677,152, U.S. Pat. No. 4,600,515 and U.S. Pat. No. 4,740,318, concerning the use of copolymers of (meth)acrylic acid, acrylamide and possibly another monomer, and finally documents U.S. Pat. No. 4,463,152, U.S. Pat. No. 3,551,479, U.S. Pat. No. 4,432,881 and U.S. Pat. No. 4,728,696 concerning copolymers of acrylamide with a surface active monomer. However, even though they enable a salt-rich aqueous medium to be thickened satisfactorily, these polymers do not have the same guarantees in terms of shearing resistance as xanthan gums.

Thus, there is a substantial requirement in terms of thickening agents which are at once thermally stable (notably at temperatures close to 150° C.), resistant to high shearing stresses, and also capable of being thickened notably in an aqueous medium in the presence of salts. Continuing its research, the Applicant has developed the use, as a thickening agent of aqueous formulation, of a water-soluble copolymer consisting of 4 particular monomers, in which the adjustment of monomeric ratios has led to completely unexpected results in terms of thickening efficacy, temperature resistance and shearing resistance.

This copolymer belongs to the previously known family of hydrophobically modified and alkaline soluble emulsions, designated under the English-language acronym HASE. These emulsions generally designate copolymers of (meth)acrylic acid, with a (meth)acrylic ester, and a hydrophobic monomer. In an aqueous medium, the latter can develop associative interactions which contribute to the thickening of the medium.

These structures have been described at length in the literature, such as through the publications of Shay et al.: JCT Research (2005), 2(6), pp 423-433, Handbook of Coatings Additives (2nd Edition) (2004), pp 405-467, PMSE Preprints (2002), 87, pp 27-29, Polymeric Materials Science and Engineering (2001), 85, pp 213-214, Proceedings of the International Waterborne, High-Solids, and Powder Coatings Symposium (2002), 29th, pp 343-355. In addition, the methods for synthesis of these polymers are also well known, as described in documents EP 0 013 836, U.S. Pat. No. 4,268,641, U.S. Pat. No. 4,421,902 and U.S. Pat. No. 4,138,381.

Conversely, nothing in the state of the art described or suggested the very particular composition of the present invention. On the contrary, it had even been known for a long time that copolymers containing at least one carboxylic monomer were likely to precipitate in the presence of divalent cations (Water Soluble Resins, 2^{nd} Ed., R. L. Davidson and M. Sitting, Rheinold, N.Y., pp 168), as contributed notably by the electrolytes in solution which are to be found in drilling fluids. This constituted a substantial prejudice for a skilled man in the art wishing to develop thickening agents of an acrylic nature in such applications.

It is however true that general HASE-type structures have been claimed in oil drilling fluids: this is revealed by the old document (published in 1980), which describes HASE-type structures, which were new at the time, and claims in a very broad fashion their use in many applications, including drilling fluids. With this regard, it is possible to imagine that the intention of the drafter of this document—by citing drilling fluids—was to cover as many applications as possible for the new claimed molecules, without however having tested the said molecules in each application. Finally, it is appropriate to add that without the contribution of the present invention, it was not possible to achieve, on the basis of document EP 0 011 806, a product which would be effective in terms of thickening a salt-rich aqueous formulation, which would be at once thermally stable and resistant to shearing.

Thus, a first object of the present invention lies in the use, as a thickening agent of an aqueous formulation, of a water-soluble or alkali-soluble copolymer, characterised in that it is constituted by, expressed as a percentage by weight of each of its monomers:
a) 30% to 45% of (meth)acrylic acid, which is preferentially methacrylic acid,
b) 50% to 60% of acrylamide and/or of N-methylol and/or of an acrylic ester chosen from among the ethyl and butyl(meth)acrylates, and which is preferentially ethyl acrylate,
c) 2% to 10% of a hydrophobic monomer of formula R₁—(R₂O)ₘ—R₃, in which:
   R₁ designates a polymerisable unsaturated group, belonging to the group of vinylics, (meth)acrylic esters, vinylic unsaturated urethanes, allylic or vinylic ethers, and is preferentially the (meth)acrylic ester group,
   R₂O designates an allylene oxide group having 1 to 6 carbon atoms, preferentially an ethylene oxide and propylene oxide group, and very preferentially an ethylene oxide group,
   m is an integer of between 20 and 50, preferentially between 30 and 40,
   R₃ designates a linear alkyl chain containing at least 16 and at most 26 carbon atoms, preferentially at least 18 and at most 22 carbon atoms,
d) 0.1% to 4% of at least one cross-linking agent, which is preferentially ethyleneglycoldimethacrylate (EDMA),

Where the sum of the percentages a), b), c) and d) is equal to 100%.

This use is also characterised in that the said copolymer is totally or partially neutralised by at least one neutralisation agent, chosen from among the hydroxides and/or oxides of calcium, magnesium, lithium or barium, the hydroxides of sodium or potassium, ammonium hydroxide, the primary, secondary or tertiary amines, their blends, and is preferentially totally or partially neutralised by sodium hydroxide.

This use is also characterised in that the said copolymer is obtained by processes of radical polymerisation in solution, in a direct or reverse emulsion, in suspension or precipitation in solvents, in the presence of catalytic systems and chain transfer agents, or again by processes of controlled radical polymerisation, and preferentially by nitroxide mediated polymerisation (NMP) or by cobaloximes, by atom transfer radical polymerisation (ATRP), by controlled radical polymerisation by sulphurated derivatives, chosen from among carbamates, dithioesters or trithiocarbonates (RAFT) or xanthates. This use is also characterised in that the said copolymer may be, before or after the total or partial neutralisation reaction, treated and separated into several phases, by one or more polar solvents belonging preferentially to the group constituted by water, methanol, ethanol, propanol, isopropanol, the butanols, acetone, tetrahydrofuran or their blends, in which one of the phases corresponds to the said copolymer.

This use of a water-soluble copolymer as a thickening agent of an aqueous formulation is also characterised in that the said formulation has a salt content of between 1 g/L and 100 g/L.

This use of a water-soluble copolymer as a thickening agent of an aqueous formulation is also characterised in that the said formulation is a formulation used in the drilling field. Non-restrictively, this may be a drilling mud, a reinjection fluid or again a fracturation fluid.

### EXAMPLES

### Example 1

This example concerns the use of various polymers of the prior art, and of a polymer according to the invention, with a view to thickening an aqueous formulation containing salts.

### Test No 1

This test illustrates the invention and uses a copolymer consisting, expressed as a % by weight of each of its monomers, of:
a) 40.3% of methacrylic acid,
b) 54.1% of ethyl acrylate, 0.7% of acrylamide, 0.85% of N-methylol acrylamide,
c) 2.5% of a hydrophobic monomer of formula R₁—(R₂O)ₘ—R₃, in which:
   R₁ designates the methacrylate group,
   R₂O designates an ethylene oxide unit with m=25,
   R₃ is a linear alkyl hydrophobic group consisting of 22 carbon atoms,
d) 1.55% of EDMA.

### Test No 2

This test illustrates the prior art and uses a copolymer consisting, expressed as a % by weight of each of its monomers, of:
a) 36.7% of methacrylic acid,
b) 53.1% of ethyl acrylate,
c) 10.2% of a hydrophobic monomer of formula R₁—(R₂O)ₘ—R₃, in which:
   R₁ designates the methacrylate group,
   R₂O designates an ethylene oxide unit with m=25,
   R₃ is a linear alkyl hydrophobic group consisting of 22 carbon atoms.

### Test No 3

This test illustrates the prior art and uses a copolymer consisting, expressed as a % by weight of each of its monomers, of:
a) 39.8% of methacrylic acid,
b) 52.1% of ethyl acrylate, 7.7% of butyl acrylate,
c) 0.4% of diallyl phthalate.

### Test No 4

This test illustrates the prior art and uses a copolymer consisting, expressed as a % by weight of each of its monomers, of:
a) 38.5% of methacrylic acid,
b) 54.9% of ethyl acrylate,
c) 6.6% of a hydrophobic monomer of formula R₁—(R₂O)ₘ—R₃, in which:
   R₁ designates the methacrylate group,
   R₂O designates an ethylene oxide unit with m=25,
   R₃ is a branched alkyl hydrophobic group consisting of 32 carbon atoms.

### Test No 5

This test illustrates the prior art and uses a copolymer consisting, expressed as a % by weight of each of its monomers, of:
a) 40.0% of methacrylic acid,
b) 50.0% of ethyl acrylate,
c) 10.0% of a hydrophobic monomer of formula R₁—(R₂O)ₘ—R₃, in which:
   R₁ designates the methacrylate group,
   R₂O designates an ethylene oxide unit with m=25,
   R₃ is a branched alkyl hydrophobic group consisting of 20 carbon atoms.

### Test No 6

This test illustrates the prior art and uses a copolymer consisting, expressed as a % by weight of each of its monomers, of:
a) 35.5% of methacrylic acid,
b) 57.8% of ethyl acrylate,
c) 6.7% of a hydrophobic monomer of formula R₁—(R₂O)ₘ—R₃, in which:
   R₁ designates the hemimaleate group,
   R₂O designates an ethylene oxide unit with m=25,
   R₃ is a branched alkyl hydrophobic group consisting of 32 carbon atoms.

### Test No 7

This test illustrates the prior art and uses a copolymer consisting, expressed as a % by weight of each of its monomers, of:
a) 37% of methacrylic acid,
b) 53% of ethyl acrylate,
c) 10.0% of a hydrophobic monomer of formula R₁—(R₂O)ₘ—R₃, in which:
   R₁ designates the methacrylate group,
   R₂O designates an ethylene oxide unit with m=25,
   R₃ is a branched alkyl hydrophobic group consisting of 20 carbon atoms.

### Test No 8

This test illustrates the prior art and uses a copolymer consisting, expressed as a % by weight of each of its monomers, of:
a) 36.2% of methacrylic acid,
b) 53.8% of ethyl acrylate,
c) 10.0% of a hydrophobic monomer of formula R₁—(R₂O)ₘ—R₃, in which:
   R₁ designates the methacrylate group,
   R₂O designates an ethylene oxide unit with m=25,
   R₃ is a branched alkyl hydrophobic group consisting of 16 carbon atoms.

### Test No 9

This test illustrates the prior art and uses a copolymer consisting, expressed as a % by weight of each of its monomers, of:
a) 37.0% of methacrylic acid,
b) 53.6% of ethyl acrylate,
c) 9.4% of a hydrophobic monomer of formula R₁—(R₂O)ₘ—R₃, in which:
   R₁ designates the methacrylurethane group (the result of the condensation between toluene di-isocyanate and ethylene glycol methacrylate)
   R₂O designates an ethylene oxide unit with m=50,
   R₃ is a nonylphenol aromatic hydrophobic group.

### Test No 10

This test illustrates the prior art and uses a copolymer consisting, expressed as a % by weight of each of its monomers, of:
a) 42.6% of methacrylic acid,
b) 54.3% ethyl acrylate, 0.87% of N-methylol acrylamide, and 0.7% of acrylamide,
c) 1.57% of EDMA.

By using 280 g of a deionised water containing 60 g/l of sodium chloride, the tests are undertaken adding 20 g of the tested thickening agent, adjusting the pH to 7.8-8.2 using 50% sodium hydroxide and by measuring the Brookfield™ viscosity at 0.3 revolutions/min. and at 25° C.

The thickened solution is then slightly diluted with the abovementioned saline water, and after homogenisation and verification of the pH the Brookfield™ viscosity is measured again. The graph of viscosity as a function of the polymer concentration is thus traced as a decreasing concentration, and the quantity of polymer required to obtain the Brookfield™ viscosity of 1,000 mPa·s is extrapolated. The quantity of polymer required is expressed as a percentage by weight of dry matter compared to the formulation mass, all the tested polymers having a dry matter concentration of 30%.

TABLE 1

| | Prior Art. | % used to obtain |
|---|---|---|
| Test n° | Inv. | 1,000 mPa · s at 0.3 revolutions/min. |
| 1 | IN | 0.76% |
| 2 | PA | 0.83% |
| 3 | PA | 0.92% |
| 4 | PA | 0.92% |
| 5 | PA | 0.94% |
| 6 | PA | 1.04% |
| 7 | PA | 1.10% |
| 8 | PA | 1.24% |
| 9 | PA | 1.45% |
| 10 | PA | 1.84% |

These results demonstrate very clearly the superiority of the polymer according to the invention, the used quantity of which required to obtain a certain level of viscosity is substantially less than that for the polymers of the prior art.

### Example 2

This example concerns the use of various polymers according to the invention and according to the prior art, which were tested at a rate of 1% by weight of dry polymer matter, compared to the total weight of the envisaged formulation. This formulation is a synthetic saline water the composition of which is given in table 2.

TABLE 2

| Mineral salts | Mass, g/l |
|---|---|
| Sodium sulphate | 0.008 |
| Sodium acid carbonate | 0.486 |
| Sodium bromide | 0.175 |
| Potassium chloride | 0.729 |
| Dihydrate calcium chloride | 3.455 |
| Hexahydrate magnesium chloride | 2.937 |
| Hexahydrate strontium chloride | 0.140 |
| Dihydrate barium chloride | 0.081 |
| Sodium chloride | 44.173 |

The formulation is produced and the pH is then modified to 8.8-9.2 using 20% sodium hydroxide. The thickened formulation is then set aside for 48 hours; its viscosity is then measured using a Haake™ Rheostress 150 viscometer at 25° C. subject to shearing of 0.1 s⁻¹.

The results are shown in table 3.

Each of the tested polymers consists of methacrylic acid (AMA), ethyl acrylate (AE), a special monomer (MS), and a cross-linking system, respectively corresponding to species a, b, c and d according to the notations of the invention; their % by weight relative to the total weight of the monomers is given in table 3.

Each special monomer consists of a monomer of formula R₁—(R₂O)ₘ—R₃, in which R₁ designates the methacrylate group, R₂O designates the ethylene oxide unit OE, and where the values of m and the nature of R₃ are given in table 3.

In table 3, it is also indicated that:
iso C16 designates the branched Guerbet alcohol with 16 carbon atoms
iso C20 designates the branched Guerbet alcohol with 20 carbon atoms
TSP designates the tristyrylphenyl radical
C22 designates a fatty linear chain having 22 carbon atoms

TABLE 3

| | | | | | | | | | cross- | |
|---|---|---|---|---|---|---|---|---|---|---|
| | Prior | | | | | | | | linking | |
| test | Ant. | | | | N- | MS | | | agent | Viscosity |
| n^{o} | Inv. | AMA % | AE % | Acrylamide % | methylol % | % | m | R3 | EDMA | (mPa · s) |
| 11 | PA | 32.65 | 54.4 | 0.7 | 0.8 | 9.9 | 25 | isoC16 | 1.55 | 20 |
| 12 | PA | 32.65 | 54.4 | 0.7 | 0.8 | 9.9 | 25 | isoC20 | 1.55 | 30 |
| 13 | PA | 40.15 | 54.1 | 0.7 | 0.8 | 2.7 | 25 | isoC16 | 1.55 | 40 |
| 14 | PA | 40.15 | 54.1 | 0.7 | 0.8 | 2.7 | 25 | TSP | 1.55 | 16 |
| 15 | IN | 40.95 | 54.8 | 0.7 | 0.8 | 1.2 | 25 | C22 | 1.55 | 200 |
| 16 | IN | 40.15 | 53.4 | 0.7 | 0.8 | 3.45 | 25 | C22 | 1.55 | 1,000 |
| 17 | IN | 39.4 | 52.6 | 0.7 | 0.8 | 4.95 | 25 | C22 | 1.55 | 1,000 |
| 18 | IN | 32.65 | 54.4 | 0.7 | 0.8 | 9.9 | 25 | C22 | 1.55 | 38,000 |
| 19 | IN | 39.25 | 52.2 | 0.68 | 0.83 | 5.5 | 45 | C22 | 1.54 | 5,200 |
| 20 | IN | 38.55 | 51.5 | 0.68 | 0.83 | 6.9 | 60 | C22 | 1.54 | 2,200 |
| 21 | IN | 38.5 | 54.1 | 0.7 | 0.85 | 2.7 | 25 | C22 | 3.15 | 900 |

A reading of table 3 demonstrates that only the polymers according to the invention, with very specific monomer ratios, for which, notably, a linear alkyl fatty chain has been used, lead to the best results in terms of thickening.

### Example 3

This example concerns the use of a polymer according to the invention, and of a reverse emulsion with a base consisting of acrylamide and of a xanthan gum according to the invention, under a very high shearing stress, and then at a very high temperature.

In each of the tests no 22 to 25 various polymers are used, with a view to thickening an aqueous formulation which is the synthetic saline water as described in example 2.

### Test No 22

This test illustrates the prior art, and uses 0.5% by dry weight of active matter (compared to the total weight of the saline aqueous formulation) of a reverse emulsion with an acrylamide base, sold under the name Flodril™ PAM 1040 by the company SNF Floerger™.

### Test No 23

This test illustrates the prior art, and uses 1.8% by dry weight of active matter (compared to the total weight of the saline aqueous formulation) of a xanthan gum, sold by the company Kelco™ under the name Kelzan™ XC.

### Test No 24

This test illustrates the invention and uses 1.2% by dry weight of active matter (compared to the total weight of the saline aqueous formulation) of an aqueous solution of a copolymer, consisting of, expressed as a % by weight of each of its polymers:
a) 40.3% of methacrylic acid,
b) 54.1% of ethyl acrylate, 0.7% of acrylamide, 0.85% of N-methylol acrylamide,
c) 2.5% of a hydrophobic monomer of formula R₁—(R₂O)ₘ—R₃, in which:
   R₁ designates the methacrylate group,
   R₂O designates an ethylene oxide unit with m=25,
   R₃ is a linear alkyl hydrophobic group consisting of 22 carbon atoms,
d) 1.55% of EDMA.

### Test No 25

This test illustrates the invention and uses 1.4% by dry weight of active matter (compared to the total weight of the saline aqueous formulation) of an aqueous solution of the copolymer according to test no 24.

For each of the abovementioned polymers:
the Brookfield™ viscosity was determined at 20 revolutions per minute, at 25° C., at t=0, noted Bk₂₀ (t=0),
it was set aside, and the Brookfield™ viscosity was determined at 20 revolutions per minute, at 25° C., at t=24 hours, noted Bk₂₀ (t=24),
a very strong shearing stress was then applied to a part of the formulation (23,000 revolutions/minute using an Ultraturax™ agitator) and the Brookfield™ viscosity was determined after shearing, at 20 revolutions per minute, at 25° C., noted Bk₂₀ (23,000 rpm),
a very high temperature (150° C.) was applied to the other part of the formulation, and the Brookfield™ viscosity was determined, at 20 revolutions per minute, at 150° C., noted Bk₂₀ (150° C.).

The results are shown in table 4 (the viscosities are expressed in mPa·s).

TABLE 4

| Test | Invention | Bk₂₀ | Bk₂₀ | Bk₂₀ | Bk₂₀ |
|---|---|---|---|---|---|
| n° | Prior Art | (t = 0) | (t = 24) | (23,000 rpm) | (150° C.) |
| 22 | PA | 760 | 1100 | 1120 | <50 |
| 23 | PA | 350 | 1055 | 210 | 70 |
| 24 | IN | 1450 | 3210 | 3215 | 5200 |
| 25 | IN | 2940 | 5100 | 5200 | 14400 |

This table demonstrates that the thickening efficacy of the polymers according to the invention, under normal temperature conditions, and without shearing (initial viscosity value and value after 24 hours) is greater than that of the polymers of the prior art.

In the presence of a very strong shearing stress the xanthan gum no longer thickens the medium, whereas the polymers according to the invention continue to produce the best results.

Finally, when the temperature is equal to 150° C., the 2 polymers of the prior art proved ineffective; the polymers according to the invention, conversely, continue to thicken the saline solution advantageously.

1. A method of thickening an aqueous formulation, comprising adding to an aqueous formulation a water-soluble or alkali-soluble copolymer, wherein the water-soluble or alkali-soluble copolymer comprises, expressed as a percentage by weight of:
a) 30% to 45% of (meth)acrylic acid,
b) 50% to 60% of acrylamide and/or of N-methylol and/or of an acrylic ester selected from the group consisting of ethyl(meth)acrylate and butyl (meth)acrylate,
c) 2% to 10% of a hydrophobic monomer of formula R₁—(R₂O)ₘ—R₃, in which:
R₁ designates a polymerisable unsaturated group, belonging to the group of vinylics, (meth)acrylic esters, vinylic unsaturated urethanes, allylic or vinylic ethers,
R₂O designates an alkylene oxide having 1 to 6 carbon atoms,
m is an integer of between 20 and 50,
R₃ designates a linear alkyl chain containing at least 16 and at most 26 carbon atoms, and
d) 0.1% to 4% of at least one cross-linking agent,
wherein the sum of the percentages a), b), c) and d) is equal to 100%.

2. The method according to claim 1, wherein the copolymer is totally or partially neutralised by at least one neutralisation agent, chosen from among the hydroxides and/or oxides of calcium, magnesium, lithium or barium, the hydroxides of sodium or potassium, ammonium hydroxide, the primary, secondary or tertiary amines, and their blends.

3. The method according to claim 1, wherein the copolymer is obtained by a process chosen from polymerizing the monomers in solution, direct or reverse emulsifying the monomers, suspending or precipitating the monomers in solvents, optionally in the presence of catalytic systems and chain transfer agents, controlled radical polymerizing the monomers, nitroxide mediated polymerizing (NMP) the monomers, atom transfer radical polymerizing (ATRP) the monomers, and controlled radical polymerizing of the monomers by sulphurated derivatives, wherein the sulphurated derivatives are chosen from carbamates, dithioesters trithiocarbonates (RAFT) or xanthates.

4. The method according to claim 1, wherein the copolymer may optionally be, before or after the total or partial neutralisation reaction, treated and separated into several phases, by at least one polar solvent, wherein the solvent is water, methanol, ethanol, propanol, isopropanol, the butanols, acetone, tetrahydrofuran or their blends, in which one of the phases corresponds to the said copolymer.

5. The method of claim 1, wherein said aqueous formulation has a salt content of between 1 g/L and 100 g/L.

6. The method of claim 1, wherein said aqueous formulation is a formulation present in the drilling field.

7. The method of claim 1, wherein b) is ethyl acrylate.

8. The method of claim 1, wherein R₁ is a (meth)acrylic ester group.

9. The method of claim 1, wherein R₂O is an ethylene oxide or a propylene oxide group.

10. The method of claim 1, wherein m is an integer between 30 and 40.

11. The method of claim 1, wherein R₃ is a linear alkyl chain comprising at least 18 and at most 22 carbon atoms.

12. The method of claim 1, wherein d) is ethyleneglycoldimethylacrylate (EDMA).

13. The method according to claim 1, wherein the copolymer is totally or partially neutralised by sodium hydroxide.
